(19) United States
(12) Patent Application Publication
(10) Pub. No.: US 2014/0278375 A1
(43) Pub. Date: Sep. 18, 2014

(54) METHODS AND SYSTEM FOR CALCULATING AFFECT SCORES IN ONE OR MORE DOCUMENTS

(71) Applicant: TRINITY COLLEGE DUBLIN, DUBLIN (IE)

(72) Inventors: Khurshid Ahmad, Dublin (IE); Andrea Zemánková, Dublin (IE)

(21) Appl. No.: 14/214,080

(22) Filed: Mar. 14, 2014

Related U.S. Application Data
(60) Provisional application No. 61/786,000, filed on Mar. 14, 2013.

(51) Int. Cl. G06F 17/27

(52) U.S. Cl. CPC G06F 17/2785
USPC 704/9

(57) ABSTRACT

A method and a computer-implemented system are provided for calculating an affect score for a text corpus, so as to facilitate analysis of the sentiment inherent to that text corpus. A list of a plurality of words is provided, wherein each word is expressing affect. Words in the text corpus are matched with words contained in the list, and a frequency of the matched words is computed. Affect words are associated along at least one semantic dimension, and those derived from the semantic dimensions and the respective frequencies are aggregated using a Choquet integral function into an affect score.

This application claims the benefit of U.S. Provisional Patent Application Ser. No. 61/786,000 filed 14 Mar. 2013, the specification of which is hereby incorporated herein by reference.

### BACKGROUND OF THE INVENTION

1. Field of the Invention

At least one embodiment of the invention relates to the field of sentiment analysis and, more particularly, to improvements in systems and methods for calculating affect scores for words, individual documents and collections of documents.

2. Description of the Related Art

The automated extraction of attitude that is articulated, and affect that is expressed by a speaker or writer, sometimes described as sentiment analysis, relies on computing key linguistic properties of a text or speech fragment or collection. For example, distribution of attitudinal and affective words, distribution of length of sentences comprising these words, distribution of grammatical structures in which the words are embedded, are the main criteria relied upon for analysing sentiment.

The extraction of “attitude”, favouring an ideology or a person or persons and reciprocally, and “affect” including positive, negative and neutral affect howsoever defined, has a long history: the study of communications in social sciences, particularly political science and sociology, based on the semi-automatic computation of the distribution of the linguistic units within a text, has a longer history and now pervades the related discipline of marketing, consumer sentiment analysis.

Affect words are used in speech and written texts to describe how the speakers or the writers, or those reported in the speech or text, are disposed or inclined about events, persons, places, or inanimate/animate objects. The words can also be used to describe the emotional state of the writer/speaker relating to the events, persons, places, or objects described in the speeches or texts.

The core dimensions of affect include evaluation, orientation and strength. For each of the three affect dimensions, words are used to express inclination, disposition or emotion. The evaluation is based on three criteria: positive, negative or neutral inclination or disposition or emotion about persons, places, or objects. A commonly used affect dimension is evaluation. Evaluation criteria are referred to by some as positive, negative or neutral sentiment.

Potency criteria include strength or weakness of the inclination, disposition or emotion towards events, persons, places, or objects. Activity criteria include activity or passivity about events, persons, places, or objects. Some affect words are used to express only one dimension; for example, evaluation or orientation or activity. Some affect words are two dimensional; for example, a combination of strength and evaluation or a combination of activity and evaluation. Some affect words are three dimensional.

Computer systems have been developed to compute the frequency of affect words from a single document or a plurality of documents. Affect words are used in evaluating an event or an object, or an idea. This evaluation is computed as a function of the frequency of one or many words used for expressing positive, negative or neutral evaluation for events, objects or ideas.

Some sentiment analysis systems output three evaluation scores of a document or plurality of documents, as the frequency of each of the three categories. Some sentiment analysis systems output a difference of positive and negative evaluation scores for a document or plurality of documents. Some sentiment analysis systems use the standard deviation of the scores, and multivariate analysis techniques, to compute a sentiment score.

The sentiment analysis methods include affect dictionary definition, either hand-constructed or defined from seed words by means of some generating methods. In some of these methods, word affect can achieve only few discrete values, routinely in the interval −1, 0, 1 or some linear transformation of these values, which can cause a low methodical accuracy. This explains the use of the whole interval [1, 1] ([−a,a], aε [symbol] ) as possible affect values, because it provides more freedom to distinguish, for example between the sentiments of expressions such as good, quite good, very good, brilliant, excellent, and more.

Known sentiment analysis systems use the Classical Weighted Arithmetic Mean (CWAM) for aggregating the affect of words in a document or plurality thereof. CWAM has shown low accuracy, particularly in the case of large documents containing an introduction and other parts which do not bear any affect, including many words with a small affect degree, which are common and not meant to express the main affect of the document, and which can obscure few important words with high affect degrees.

A further example is disclosed by Reis et at in WO 2009/094664, which proposed an aspect-based sentiment summarisation relying upon on a pluralisation of pre-annotated texts comprising sentiment bearing sentences about a property of an entity. Sentiment in the embodiment presented by Reis et at relates to negative and positive scores, which are presented to the end-user and a simple weighing technique is used.

A further example is disclosed by Chowdhury et at in US 2010/0050118, which proposed a similar aspect-based approach to rank document according to the frequency of the occurrence of various phrases pre-labelled with sentiment and aspect labels. So-called Opinion Ranking techniques are used which are, in turn, based on information retrieval matrices of precision and recall.

It is an object of at least one embodiment of the invention to provide an improved system and method for aggregating affect scores in a document collection.

### BRIEF SUMMARY OF THE INVENTION

The object is addressed by a method, computer-readable storage medium, and computer-implemented system for calculating an affect score for a text corpus.

An embodiment of the method comprises the step of providing a list of a plurality of words, wherein each word is expressing affect. The method further comprises matching words in the text corpus with words contained in the list and computing a frequency of the matched words. The method associates affect words along at least one semantic dimension and aggregates affect words derived from the semantic dimensions and the respective frequencies using a Choquet integral function into an affect score. The Choquet integral function can be understood as the Choquet integral. However, this is defined only for unipolar case. In this method a bipolar Choquet integral can be used and can be defined as a balancing Choquet integral.

In an embodiment of the method, the step of aggregating may further comprise generating a data matrix containing and affect degree of each word and the computed frequency of the word, and applying the balancing choquet integral function to the data matrix.

In an embodiment of the method, the affect of each word in the list may expressed in one or more categories corresponding to Osgood dimensions (negative, positive, strong, weak, active, passive). In a useful variant of this embodiment, the or each semantic dimension may be selected from a group of semantic dimensions comprising at least negative/positive, strong/weak, active/passive and virtue/vice.

In an embodiment of the method, the text corpus preferably comprises one or more documents.

In variant of this embodiment wherein the text corpus comprises several documents, the text corpus may further comprises a training set of documents related to a same domain, and the step of providing a list further comprises labelling training set documents as negative or positive for the training set. In a further variant of this embodiment, the step of computing a frequency may further comprise computing a frequency of each word in each of the positive and negative documents contained in the training set.

In a further variant of the embodiment wherein the text corpus comprises several documents, the step of aggregating may further comprise calculating a weighted average of the respective affect score of each document.

Embodiments of the computer-readable storage medium and computer-implemented system comprise a listing module configured to generate a list of a plurality of words, wherein each word is expressing affect; a matching module configured to match words in the text corpus with words contained in the list; a frequency module configured to compute a frequency of the matched words; an associating module configured to associate affect words along at least one semantic dimension; and an aggregating module configured to aggregate affect words derived from the semantic dimensions and the respective frequencies using a Choquet integral function into an affect score.

In an embodiment of the computer-implemented system, the system may be distributed over a network and at least a portion of the text corpus is remotely stored.

At least one embodiment of the invention effectively provides a system and method improving CWAM techniques, wherein the influence of words with high affect degrees is amplified. A practical context occurs for example with movie reviews, wherein the plot description can obscure the affect of the document, such that a list of domain-important words and aggregation which stresses the main affect bearing words in the document are needed.

Further aspects of at least one embodiment of the invention are as set out in the appended claims.

### BRIEF DESCRIPTION OF THE DRAWINGS

At least one embodiment of the invention will be more clearly understood from the following description thereof, given by way of example only, with reference to the accompanying drawings, in which:

FIG. 1 shows a networked environment comprising a communication network and a plurality of data processing terminals, including a terminal configured to analyse sentiment, a local text corpus store and a remote terminal configured as a remote text corpus store;

FIG. 2 is a logical diagram of a typical hardware architecture of each of the data processing terminals shown in FIG. 1;

FIG. 3 provides a functional representation of a system for computing the affect degree of a text document, as provided by the terminal configured to analyse sentiment of FIGS. 1 and 2;

FIG. 4 is a flow chart of a method for computing the affect degree of a text document according to a first embodiment of the invention;

FIG. 5 is a flow chart of two alternative methods for computing the affect degree of a text document according to further embodiments of the invention;

FIG. 6 shows three possible scales corresponding to the choice of categories in category selection;

FIGS. 7A to 7D plot the dependence of two semantic dimensions, precision and recall, on a parameter when computing the affect degree of positive and negative documents; and

FIGS. 8A to 8C plot the dependence of a further semantic dimension, F-index, on the parameter when computing the affect degree of positive and negative document.

### DETAILED DESCRIPTION OF THE INVENTION

There will now be described by way of example a specific mode contemplated by the inventors. In the following description numerous specific details are set forth in order to provide a thorough understanding. It will be apparent however, to one skilled in the art, that embodiments of the invention may be practiced without limitation to these specific details. In other instances, well known methods and structures have not been described in detail so as not to unnecessarily obscure the description.

A networked environment 100 is shown in FIG. 1, wherein a first data processing terminal 101 is configured according to at least one embodiment of the invention for performing a local word analysing method under which sentiment inherent to the words used in local and/or remote documents is computed. The data processing terminal 101 emits and receives data encoded as digital signals over wired data transmissions 102 conforming to the IEEE 802.3 (‘Gigabit Ethernet’) standard, wherein each signal is relayed respectively to or from the computing device by a modem-router device 103 interfacing the computing device 101 to a Wide Area Network (WAN) communication network 104, a typical example of which is the Internet 104.

The data processing terminal 101 also writes data to and reads data from a local storage device 105 which stores electronic documents 110 comprising words, in the example movie reviews. The local storage device 105 may be a standalone device such as a Universal Serial Bus (‘USB’)-connectable drive 105 or a Local Area Network (‘LAN’)-networked device such as a Network-Attached Storage (‘NAS’) drive 105, whereby digital signals may be exchanged between the terminal 101 and the storage device 105 either through a USB communication link 106 or, if it is a NS, then again through modem-router device 103.

In the example, the networked environment 100 comprises a further data processing terminal 107, remote from the first terminal 101 and which again stores electronic documents 110 comprising words like the storage device 105, in the example again movie reviews. The data processing terminal 107 again emits and receives data encoded as digital signals over wired data transmissions 102 conforming to the IEEE 802.3 (‘Gigabit Ethernet’) standard, wherein each signal is relayed respectively to or from the computing device by another modem-router device 103 interfacing the remote device 107 to the WAN 104, over which both terminals 101, 107 may thus communicate.

A typical hardware architecture of each of the data processing terminals 101, 107 is now shown in FIG. 2 in further detail, again by way of non-limitative example and to illustrate an technical implementation context for the sentiment analysis techniques disclosed herein. The data processing device 101 is thus a computer configured with a data processing unit 201, data outputting means such as video display unit (VDU) 202, data inputting means such as HiD devices, commonly a keyboard 203 and a pointing device (mouse) 204, as well as the VDU 202 itself if it is a touch screen display, and data inputting/outputting means such as the wired network connection 102 to the communication network 104 via the modem-router 103, a magnetic data-carrying medium reader/writer 206 and an optical data-carrying medium reader/writer 207.

Within data processing unit 201, a central processing unit (CPU) 208 provides task co-ordination and data processing functionality. Sets of instructions and data for the CPU 208 are stored in memory means 209 and a hard disk storage unit 210 facilitates non-volatile storage of the instructions and the data. A wireless network interface card (NIC) 211 provides the interface to the network connection 205. A universal serial bus (USB) input/output interface 212 facilitates connection to the keyboard and pointing devices 203, 204 as well as the local storage device 105 if it is USB-compliant and connected.

All of the above components are connected to a data input/output bus 213, to which the magnetic data-carrying medium reader/writer 206 and optical data-carrying medium reader/writer 207 are also connected. A video adapter 214 receives CPU instructions over the bus 213 for outputting processed data to VDU 202. All the components of data processing unit 201 are powered by a power supply unit 215, which receives electrical power from a local mains power source and transforms same according to component ratings and requirements.

Generally, the data processing terminals 101, 107 may be any portable or desktop data processing device having at least data storage means and data processing or computing means, and preferably networking means apt to establish a data communication with a LAN or WAN. It will be readily understood by the skilled person from the foregoing, that the example networked environment and the data processing and storing devices described herein with reference to FIGS. 1 and 2 are provided by way of non-limitative example only.

The present method generalizes two related intuitive notions about how to compute positive and negative affect content of a document. The first relates to how the affect of a word or phrase is measured in a document. The second relates to the aggregation of the affect content of individual words/phrases comprised in the document.

The method derives a fuzzy polarity lexicon, then focuses on an aggregation function which aggregates the affect degrees of words contained in the document to the overall document affect degree. Moreover, it shows the dependence of the classification performance on the parameter used in the aggregation by means of the balancing Choquet integral.

With reference to FIG. 3, in practical terms the method can be encoded as a set of processor instructions stored in the HDD 210 and which, when loaded for use by the CPU 208 into the RAM 209, embodies a state machine comprising a plurality of data processing modules including a listing module 301 configured to generate a list of a plurality of words, wherein each word is expressing affect; a matching module 302 configured to match words in the text corpus with words contained in the list; a frequency module 303 configured to compute a frequency of the matched words; an associating module 304 configured to associate affect words along at least one semantic dimension; and an aggregating module 305 configured to aggregate affect words derived from the semantic dimensions and the respective frequencies using a Choquet integral function into an affect score.

With reference to FIG. 4, at its simplest the method consists in selecting a local (105) or remote (107) text corpus 110 at step 401, generating a list of affect words that may be found in the corpus at step 402, then reading the corpus and matching the listed words at step 403 in order to acquire the analysis data. Thereafter, the method computes the frequency of the matched words across the corpus at step 404 and associates the affect words with at least one more semantic dimension at step 405. At step 406, a matrix M of the analysis data is generated, which included the affect words, their respective frequencies and associated semantic dimensions. A Choquet Integral function is applied to the data matrix M at step 407 and the affect score for the text corpus is consequently output at step 408.

Specific aspects of the above method steps are further described hereafter, with reference to FIGS. 5 to 8C.

Step 501, data acquisition and definition: data is either taken from a collection saved on a hard disk or the data are collected from sources published on the Internet. A dictionary or lexicon is first generated, which contains words along with categories corresponding to Osgood dimensions (negative, positive, strong, weak, active, passive). More categories may be provided, as will be readily understood by the skilled reader.

All words which do not belong to the positive or negative category are removed. Next, words with multiple entries are also removed: for a word with multiple entries, the entry which corresponds the most to the given domain is selected. If there is no such entry or if no specific domain is given, multiple entries are combined after computation of the affect degree, by taking a simple average of affect degrees of all entries for that word as the affect degree.

Step 502a, training set selection: First find two sets of text documents related to the same domain, a first labelled as positive and a second labelled as negative. The sets should be sufficiently large. The same substantial number of documents is selected from each of these sets, for forming a training set. Documents that are left can be then used as a testing set to see the method precision.

Step 503a, dual frequency counter: For each word in the created dictionary, the frequency of this word is respectively computed both in positive documents contained in the training set constructed at 502a, and denoted by fₚ(w), and in negative documents contained in the same training set constructed at 2a above, and denoted by fₙ(w).

Step 503b, category selection: There are three possibilities in the method how to choose the categories that are involved in affect degree computation. The main categories that influence the affect degree are negative/positive. The second most important categories are strong/weak and the last categories active/passive have minor influence. This description is reflected in the three possibilities 601, 602 and 603 depicted in FIG. 6. In possibility 601 only negative/positive categories are included, in possibility 602 both negative/positive and strong/weak categories are included and in possibility 602, all negative/positive, strong/weak and active/passive categories are included.

Step 504a, affect degree definition: in the case when the training set is available the affect degree of a word w is given by:

$${d}_{sent} ( w ) = \frac{f {r}_{p} ( w ) - f {r}_{n} ( w )}{f {r}_{p} ( w ) + f {r}_{n} ( w )} ,$$

where fₚ(w) and fₙ(w) are defined above.

Here dₛₑₙₜ(w)=1 if and only if the word w occurs only in positive documents from the training set and dₛₑₙₜ(w)=−1 if and only if the word w occurs only in negative documents from the training set. There is also dᵣₑₗ(w)ε[−1,1] for every word w.

Step 504b, affect degree definition based on selected categories: there are two possibilities in the method how the affect degree of a word is defined.

The first method incorporates the categories positive/negative, strong/weak, active/passive together with virtue/vice. Here the affect of a word w is given by:

d(w)=BS(w)·PF(w)·AF(w),

wherein the value of the potency factor PF(w)=1 if w is strong and not weak, PF(w)=0.4 if w is weak and not strong and PF(w)=0.9 otherwise. Similarly, the value of the activity factor AF(w)=1 if w is active and not passive, AF(w)=0.4 if w is passive and not active and AF(w)=0.9 otherwise. The basic sentiment BS is given by:

| if pn(w) is | and vv(w) | then BS(w) is |
|---|---|---|
| 1 | 1 | 1 |
| 1 | 0 | 0.9 |
| 1 | −1 | 0.6 |
| 0 | 1 | 0.4 |
| 0 | 0 | 0 |
| 0 | −1 | −0.4 |
| −1 | 1 | −0.6 |
| −1 | 0 | −0.9 |
| −1 | −1 | −1 |

Here again pn(w)=1 (vv(w)=1) if w is positive(virtue) and not negative(vice), pn(w)=0 (vv(w)=0) if w is negative(vice) and not positive(virtue), and pn(w)=0 (vv(w)=0) otherwise.

The second possibility is defined in FIG. 6. In the case of a more sophisticated dictionary, where categories strong/weak and active/passive are not simply given by True/False, but by a number sw(ap) from [−1,1] ([−a, a], aε [symbol] ), the affect degree is given by np(sw+2) in case 602 and by np(3sw+ap+5) in case 603.

Step 505a, list of important words selection: First words are divided into two groups, those words with positive relevance degree wεPᵣ and those words with negative relevance degree wεNᵣ. Words with 0 relevance degree are discarded.

From both lists Pᵣ and Nᵣ, only those words are selected for which the absolute value of their relevance degree satisfy |dᵣₑₗ(w)|>s, where sε[0,1]. This in fact means that for all selected words the following applies:

frₚ(w)>(1+s)/(1−s)frₙ(w),

and

frₙ(w)>(1+s)/(1−s)frₚ(w).

This will ensure that chosen words are intrinsic for positive (negative) documents, and not for negative (positive) documents. Thus two sets of words P′ᵣ, N′ᵣ are obtained with P′ᵣ⊂Pᵣ and N′ᵣ⊂Nᵣ.

From both modified lists P′ᵣ, and N′ᵣ only those words are selected for which the sum:

frₚ(w)+frₙ(w)>m,mε [symbol] .

This will ensure that words with low frequency in both positive and negative documents will not be selected, because they are not intrinsic for neither positive nor negative documents. P, N are obtained with P⊂P′ᵣ and N⊂N′ᵣ.

Step 505b, list of important words selection: In the case when the affect degree is derived from categories, the list of important words is obtained from dictionary defined above at 2 by removal of words with 0 affect degrees.

Step 506, frequency analyzer: the frequency of the word in the text document is computed, for each word in the list of important words.

Step 507, data matrix composition: In the data matrix each column corresponds to one word: the first row contains the affect degree of the word and the second row contains the frequency of the word obtained.

Step 508, aggregation: The balancing Choquet integral described below is applied on the data matrix.

Definition 8(i) For an input vector x=(x1, . . . , x1), xεRⁿ consider the set

Cₒ={jε{1, . . . , n}|xⱼ=0},

and the value classes of input x, defined as

Cᵢ⊂{1, . . . , n},Cᵢ≠φ,i=1, . . . , p

such that

0<|xⱼ|=|xₖ|=|Cᵢ|∀k,jεCᵢ,

and

$$\vert {x}_{k} \vert < \vert {x}_{j} \vert ∀ k ∈ {C}_{i} , j ∈ \vert {C}_{r} with i < r , \& {{⋃}_{i = 0}}^{p} {C}_{i} = \{ 1 , … , n \}$$

The sets which contains positive and negative values of x are:

Cᵢ⁺={jεCᵢ|xⱼ>0},&Cᵢ⁻=Cᵢ\Cᵢ⁺

and the partial unions of Cᵢ are defined as Dᵢ

$${D}_{i} = {{⋃}_{k = i}}^{p} {C}_{k}$$

Definition 8(ii) Let m:2^{X}→[0,1] be a normed fuzzy measure on X. Then the balancing Choquet integral is given by:

$${ϕ}_{m} ( x ) = {\sum }_{i = 1}^{p} \vert {C}_{i} \vert ( m ( {C}_{i}^{+} ⋂ {D}_{i + 1} ) - m ( {C}_{i}^{-} ⋂ {D}_{i + 1} ) ) , \\ where {D}_{p = 1} = ∅ .$$

Step 509, global aggregation: Since the affect degrees of the documents should be no longer obscured by any misleading words, the global aggregation is done by a weighted average of affect degrees of documents weighted by a trustworthiness of each document (if trustworthiness is not available simple average is taken instead).

Step 10, result: the output is the affect degree of the collection of documents. More outputs can be given including number of articles (per day/month/total), best/worst document, average number of words per document etc.

In the example, a set of movie reviews was downloaded from http://www.cs.cornell.edu/People/pabo/movie-review-data, which consists of two sets of document wherein the first group of 1000 documents are classified as positive and the second group of 1000 documents are classified as negative. The data does not however include any reviews which could be considered as neutral.

The approach focuses on unigrams. It can be argued that the words used in affect documents (for example movie reviews) are often used in a different meaning as their affect degree would indicate. This can be caused due to the specific language authors (reviewers) use. Therefore the use of the first method based on a training set is expected to give good results. Here (a) selected words are intrinsic for positive (negative) documents, (b) list of selected words is considerably small (in our studies where each training set consisted of 900+900 documents there was usually around 400 words in P U N) and therefore the computational time is small. Note that in some methods the list of features consists of over 16000 elements (words and phrases).

Movie reviews were analysed according to both embodiments of the method. The frequency fuzzy measure derived from the weight generator h(x)=x^{p}, p≧1 was used for the balancing Choquet integral. The Frequency fuzzy measure can also be derived if fᵢ is a normalized frequency of i-th word (normalized means that frequencies sum up to 1) then the frequency fuzzy measure of the set of words A generated by the weight generator h(x)=x^{p} is given by m(A)=1−(1−Σ_{iεA}fᵢ)^{p}.

The influence which the value of parameter p has upon the classification accuracy of the test movie reviews can be observed in the following tables, which also permit a comparison of the two embodiments of the method described above. With reference to the frequency fuzzy measure mentioned, the balancing Choquet integral is equal to the weighted mean, with weights equal to normalized frequencies, when p=1.

A matrix M was constructed for each document, wherein each column corresponds to one word with a non-zero affect degree from a given document. The first row of the matrix M contains the affect degree of words and the second row contains the frequency of words. This second row of the matrix M is used in order to derive a frequency fuzzy measure m by means of a weight generator h(x)=x^{p} for p≧1. The Frequency fuzzy measure can also be derived if fᵢ is a normalized frequency of i-th word (normalized means that frequencies sum up to 1) then the frequency fuzzy measure of the set of words A generated by the weight generator h(x)=x^{p} is given by m(A)=1−(1−Σ_{iεA}fᵢ)^{p}.

The balancing Choquet integral with respect to the measure m is afterwards applied to the first row of matrix M.

In the first method based on a training set, the first 100 positive and 100 negative movie reviews were selected as a testing set, and the remaining 900 positive and 900 negative documents were used as a training set.

In the derivation of relevance degrees, the following values were used s=0.15 (this value provided best results across all tests performed), m=10 for words from P′ᵣ and m=8 for words from N′ᵣ. This difference in m was done due to the fact that for m=10 in the case of words with negative relevance degree only few words were selected.

If the described word selection is performed on whole set of 1000+1000 documents, then the first 10 selected words (with highest absolute difference |frₚ(w)−frₙ(w)|) are:

words with positive relevance degree
(AD2 = Affect Degree 2)

| | frₚ | frₙ | frₚ − frₙ | dᵣₑₗ | AD2 |
|---|---|---|---|---|---|
| Great | 752 | 397 | 355 | 0.309 | 0.810 |
| Well | 1123 | 783 | 340 | 0.178 | 0.810 |
| Best | 829 | 504 | 325 | 0.244 | 0.810 |
| Love | 661 | 458 | 203 | 0.181 | 0.486 |
| War | 275 | 95 | 180 | 0.486 | −0.729 |
| True | 283 | 127 | 156 | 0.380 | 0.810 |
| Perfect | 248 | 95 | 153 | 0.446 | 0.900 |
| Dark | 214 | 98 | 116 | 0.372 | −0.729 |
| Wonderful | 166 | 51 | 115 | 0.530 | 0.810 |
| Excellent | 146 | 38 | 108 | 0.587 | 0.810 |

words with negative relevance degree
(AD2 = Affect Degree 2)

| | frₚ | frₙ | frₚ − frₙ | dᵣₑₗ | AD2 |
|---|---|---|---|---|---|
| Bad | 361 | 1035 | −674 | −0.483 | −0.810 |
| Plot | 596 | 917 | −321 | −0.212 | −0.900 |
| Worst | 49 | 259 | −210 | −0.682 | −0.810 |
| Stupid | 45 | 208 | −163 | −0.644 | −0.810 |
| Better | 391 | 531 | −140 | −0.152 | 0.810 |
| Wste | 22 | 121 | −99 | −0.692 | −0.360 |
| Worse | 74 | 171 | −97 | −0.396 | −0.810 |
| Ridiculous | 118 | −96 | 116 | −0.686 | −0.360 |
| Mess | 33 | 126 | −93 | −0.585 | −0.810 |
| Awful | 21 | 111 | −90 | −0.682 | −0.900 |

Here Affect Degree 2 originates in method based on categories and the basic sentiment approach. The training set was selected several times and the average precision and recall was computed for the testing set.

The average precision, recall and F-index for positive and negative documents, and also the accuracy measure for p=1, p=2, p=3 and p=4, can be observed the following tables:

| p = 1 | Positive | Negative |
|---|---|---|
| Precision | 0.6930 | 0.8908 |
| Recall | 0.9275 | 0.5875 |
| F-index | 0.7929 | 0.7068 |

| | |
|---|---|
| accuracy | 75.75% |

| p = 2 | Positive | Negative |
|---|---|---|
| Precision | 0.7481 | 0.8752 |
| Recall | 0.9000 | 0.6950 |
| F-index | 0.8165 | 0.7736 |

| | |
|---|---|
| accuracy | 79.75% |

| p = 3 | Positive | Negative |
|---|---|---|
| Precision | 0.7575 | 0.8645 |
| Recall | 0.8875 | 0.7125 |
| F-index | 0.8165 | 0.7795 |

| | |
|---|---|
| accuracy | 80.00% |

| p = 4 | Positive | Negative |
|---|---|---|
| Precision | 0.7569 | 0.8420 |
| Recall | 0.8650 | 0.7200 |
| F-index | 0.8069 | 0.7754 |

| | |
|---|---|
| accuracy | 79.25% |

In the second method based on categories, the Basic Sentiment computation technique was used wherein, for the computation of precision and recall, the classification was based each time on the set of selected 100 positive documents and 100 negative documents.

The testing set was selected several times and the average precision and recall was computed. The average precision, recall and F-index for positive and negative documents, as well as classification accuracy, can all be observed in the following tables for each of p=1, p=2, p=3 and p=4.

| p = 1 | Positive | Negative |
|---|---|---|
| Precision | 0.5395 | 0.7323 |
| Recall | 0.9225 | 0.2125 |
| F-index | 0.6808 | 0.3293 |

| | |
|---|---|
| accuracy | 56.75% |

| p = 2 | Positive | Negative |
|---|---|---|
| Precision | 0.5722 | 0.7014 |
| Recall | 0.8425 | 0.3700 |
| F-index | 0.6815 | 0.4844 |

| | |
|---|---|
| accuracy | 60.63% |

| p = 3 | Positive | Negative |
|---|---|---|
| Precision | 0.6099 | 0.6802 |
| Recall | 0.7575 | 0.5150 |
| F-index | 0.6755 | 0.5857 |

| | |
|---|---|
| accuracy | 63.63% |

| p = 4 | Positive | Negative |
|---|---|---|
| Precision | 0.6109 | 0.6413 |
| Recall | 0.6825 | 0.5650 |
| F-index | 0.6442 | 0.5999 |

| | |
|---|---|
| accuracy | 62.38% |

The extent to which the precision, recall and F-index values for the first 100 positive and 100 negative movie reviews depend upon the parameter p can be observed in the graphs of FIGS. 7A to 8C, as well as a comparison of the classification method based on affect degree with the method based on relevance degree.

FIG. 7A shows the dependence of precision on parameter p for positive movie reviews. FIG. 7B shows the dependence of precision on parameter p for negative movie reviews. FIG. 7C shows the dependence of recall on parameter p for positive movie reviews. FIG. 7D shows the dependence of recall on parameter p for negative movie reviews. In each of FIGS. 7A to 7D, the dashed line is associated with the classification method based on relevance degree and the plain line is associated with the classification method based on affect degree.

FIG. 8A shows the dependence of F-index on parameter p for positive movie reviews. FIG. 8B shows the dependence of F-index on parameter p for negative movie reviews. FIG. 8C shows the dependence of classification accuracy on parameter p. In each of FIGS. 8A to 8C, the dashed line is associated with the classification method based on relevance degree and the plain line is associated with the classification method based on affect degree.

Embodiments of the invention described with reference to the drawings comprise a computer apparatus and/or processes performed in a computer apparatus. However, at least one embodiment also extends to computer programs, particularly computer programs stored on or in a carrier adapted to bring at least one embodiment of the invention into practice. The program may be in the form of source code, object code, or a code intermediate source and object code, such as in partially compiled form or in any other form suitable for use in the implementation of the method according to at least one embodiment of the invention. The carrier may comprise a storage medium such as ROM, e.g. CD ROM, or magnetic recording medium, e.g. a memory device or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

Embodiments of the invention are not limited to the embodiments hereinbefore described but may be varied in both construction and detail.

1. A method of calculating an affect score for a text corpus, comprising the steps of:
providing a list of a plurality of words, wherein each word is expressing affect;
matching words in the text corpus with words contained in the list;
computing a frequency of the matched words;
associating affect words along at least one semantic dimension; and
aggregating affect words derived from the semantic dimensions and the respective frequencies using a Choquet integral function into an affect score.

2. The method according to claim 1, wherein the step of aggregating further comprises generating a data matrix containing and affect degree of each word and the computed frequency of the word, and applying a balancing choquet integral function to the data matrix.

3. The method according to claim 1, wherein the affect of each word in the list is expressed in one or more categories corresponding to Osgood dimensions comprising negative, positive, strong, weak, active and passive.

4. The method according to claim 3, wherein the or each semantic dimension is selected from a group of semantic dimensions comprising at least negative/positive, strong/weak, active/passive and virtue/vice.

5. The method according to claim 1, wherein the text corpus comprises one or more documents.

6. The method according to claim 5, wherein the text corpus further comprises a training set of documents related to a same domain, and the step of providing a list further comprises labelling training set documents as negative or positive for the training set.

7. The method according to claim 5, wherein the step of computing a frequency further comprises computing a frequency of each word in each of the positive and negative documents contained in the training set.

8. The method according to claim 5, wherein the step of computing a frequency further comprises computing a frequency of each word in each of the positive and negative documents contained in the training set and aggregating further comprises calculating a weighted average of the respective affect score of each document.

9. A computer-readable storage medium having computer-executable code encoded therein for calculating an affect score for a text corpus, comprising:
a listing module configured to generate a list of a plurality of words, wherein each word is expressing affect;
a matching module configured to match words in the text corpus with words contained in the list;
a frequency module configured to compute a frequency of the matched words;
an associating module configured to associate affect words along at least one semantic dimension; and
an aggregating module configured to aggregate affect words derived from the semantic dimensions and the respective frequencies using a Choquet integral function into an affect score.

10. A computer-implemented system for calculating an affect score for a text corpus, comprising at least one readable data storage medium having computer-executable code encoded therein, the code comprising:
a listing module configured to generate a list of a plurality of words, wherein each word is expressing affect;
a matching module configured to match words in the text corpus with words contained in the list;
a frequency module configured to compute a frequency of the matched words;
an associating module configured to associate affect words along at least one semantic dimension; and
an aggregating module configured to aggregate affect words derived from the semantic dimensions and the respective frequencies using a Choquet integral function into an affect score.

11. The computer-implemented system according to claim 10, wherein the system is distributed over a network and at least a portion of the text corpus is remotely stored.
